(19) United States
(12) Patent Application Publication
(10) Pub. No.: US 2023/0111287 A1
(43) Pub. Date: Apr. 13, 2023

(54) LEARNING PROXY MIXTURES FOR FEW-SHOT CLASSIFICATION

(71) Applicant: HUAWEI TECHNOLOGIES CO., LTD., Shenzhen (CN)

(72) Inventors: Xu Lan, London (GB); Sarah Parisot, London (GB); Steven George McDonagh, London (GB); Weiran Huang, Shenzhen (CN)

(21) Appl. No.: 18/065,405

(22) Filed: Dec. 13, 2022

Related U.S. Application Data
(63) Continuation of application No. PCT/CN2020/096349, filed on Jun. 16, 2020.

(51) Int. Cl. G06N 20/00; G06V 10/74; G06V 10/764; G06V 10/77

(52) U.S. Cl. CPC G06N 20/00; G06V 10/74; G06V 10/764; G06V 10/7715

(57) ABSTRACT

A computer system and method are provided for training a machine learning system to perform a classification task by classifying input data into one of a plurality of classes. The system is configured to: receive per class training data from which per class representations can be derived, wherein each class is described by multiple representations; process the training data to form, for at least one class, a first proxy for a relatively global portion of an item of training data and multiple proxies for distinct relatively local portions of the item of training data, each proxy corresponding to a representation of the data belonging to that class.

### CROSS-REFERENCE TO RELATED APPLICATIONS

This application is a continuation of International Application No. PCT/CN2020/096349, filed on Jun. 16, 2020. The disclosure of the aforementioned application is hereby incorporated by reference in entirety.

### FIELD OF THE INVENTION

Embodiments of this application relate to object classification, in particular using few-shot classification to classify objects in images.

### BACKGROUND

Deep Neural Networks for image classification may reach super-human performance when trained on large amounts of annotated data. They can however be highly susceptible to overfitting when training data is limited. Therefore new, rare classes, where annotated data is difficult to acquire, may result in low classification accuracy. In contrast, humans are capable of recognizing new classes from very few examples.

Few-Shot Learning (FSL) aims to emulate human behaviour by teaching models to recognise and handle new, previously unseen classes in data-limited regimes. Previous work on FSL can generally be divided into two general categories: meta-gradient learning and metric-learning.

Meta-gradient learning based methods focus on teaching a model to adapt quickly to new classes via a small number of regular gradient descent iterations. Many recent meta-gradient methods train a meta-learner using the learning-to-learn paradigm. A popular strategy within this paradigm involves finding optimal network parameter initializations, such that fine-tuning becomes fast and requires only a few weight updates.

In metric-learning based techniques, a distance metric between a query image and a set of labelled images is learned such that the query image is closest to labelled images of the same class. The key idea of metric learning is to learn deep embeddings of input samples that minimises a pre-defined distance metric between samples of the same class. These methods typically rely on class proxies, which are used to classify the unlabelled images via a nearest neighbour strategy. Proxies can be defined as a global representation of a class that is calculated from the embedding of a set of annotated support images. The crux of metric learning involves learning a good global class representation per class that is used to classify unlabelled images at test time, typically with a nearest neighbour strategy. The common approach for defining the representative class proxy involves using the average feature representation of a set of labelled images. Metric learning approaches constitute a highly popular strategy, learning discriminative representations such that images, containing different classes, are well separated in an embedding space.

Despite significant improvements achieved by metric learning approaches, existing metric based FSL approaches may still suffer from an intrinsic drawback due to the general assumption that each category can be summarised using a single proxy which is then used as a reference to infer class labels. By only considering a uni-modal proxy per class, such methods are unable to capture complex multi-modal class distributions that often exist in real-world problems and fail to capture subtle differences between similar classes, as illustrated in FIG. 1, which shows a t-Stochastic neighbour embedding visualization of feature embeddings for the support and query images in the minilmageNet test stage under the 5-way 1-shot setting (Qi, H., Brown, M., and Lowe, D. G., “Low-shot learning with imprinted weights”, CVPR, 2018). This illustrates two drawbacks of singe proxy metric learning methods. Firstly, the proxy can lack representative power and be out of distribution, as shown at 101. Secondly, a single proxy cannot accurately capture class multi-modal distributions, as shown at 102 and 103.

Additionally, the performance of such models can be sensitive to the proxy quality and the models may be of limited discriminative power.

Relying on multiple proxies was considered in the methods described in Allen, K. R., Shelhamer, E., Shin, H., and Tenenbaum, J. B., “Infinite mixture prototypes for few-shot learning”, arXiv, 2019 and Li, W., Wang, L., Xu, J., Huo, J., Gao, Y., and Luo, J., “Revisiting local descriptor based image-to-class measure for few-shot learning”, CVPR, 2019. These methods propose multiple proxy representations as clusters and local descriptors. However, these approaches suffer from the limitations that proxies may not be optimised for diversity, limiting the benefits of the multiple representations. Furthermore, local descriptors are not regularised, yielding proxies of potential poor representative power due to the use of local inputs.

Furthermore, in contrast to learning image level representations, global image-based measures may be too coarse to be effective in few-shot scenarios, where samples are scarce. Li, W., Wang, L., Xu, J., Huo, J., Gao, Y., and Luo, J., “Revisiting local descriptor based image-to-class measure for few-shot learning”, CVPR, 2019 proposes to learn local descriptors for their image-to-class measure. Allen, K. R., Shelhamer, E., Shin, H., and Tenenbaum, J. B., “Infinite mixture prototypes for few-shot learning”, arXiv, 2019 alternatively uses Infinite Mixture Prototypes (IMP). The IMP approach represents each class as a set of clusters (prototypes), each consisting of class image representations. However, tackling class representation with the IMP clustering strategy may not afford any mechanism to account for prototype diversity.

It is desirable to develop an improved method for few shot classification capable of recognizing new, previously unseen classes of objects using only limited training samples that overcomes these problems.

### SUMMARY OF THE INVENTION

According to one aspect there is provided a computer system configured for training a machine learning system to perform a classification task by classifying input data into one of a plurality of classes, the system being configured to: receive per class training data from which per class representations can be derived, wherein each class is described by multiple representations; process the training data to form, for at least one class, a first proxy for a relatively global portion of an item of training data and multiple proxies for distinct relatively local portions of the item of training data, each proxy corresponding to a representation of the data belonging to that class; and for each item of training data: assess the match between that item of training data and the proxies, estimate a class for the item of training data in dependence on the level of match, and adjust the proxies by updating a weighting matrix to reduce the distance between that item of training data and the proxy for the estimated class.

This may alleviate the inherent bias and limitations linked to the use of a single representation and may allow for the learning of richer proxy representations that can capture latent data distributions accurately and enhance model robustness. Forming a combination of local and global descriptors may enable computation of a set of diverse class proxies that focus on different aspects of the image. This may teach models to handle new classes in data-limited regimes and therefore to emulate the related human ability.

The proxies may be defined by weights of a model learned by the machine learning system. This may allow the proxies to be efficiently learned.

The step of processing the training data may further comprise, for at least one class, employing a self-supervised rotation prediction training task to strengthen the representation power of the proxies. Using a self-supervised rotation loss task may regularise the learning process on local inputs and strengthen the local proxies' representative power, yielding robust and class-representative local proxies.

The step of processing the training data may comprise, for at least one class, forming multiple proxies by a process configured to encourage variance between those proxies. This may maximise ensembling performance.

The system may be configured to assess the match between an item of training data and the proxies by a soft attention mechanism. This may improve the accuracy of the trained model.

The soft attention mechanism may comprise processing the degree of match between the item of training data and each of the proxies in accordance with a soft attention algorithm, and the computer system may be configured to train the soft attention algorithm to improve the propensity of the system to correctly classify input data. A soft attention gate may be trained to merge classification decisions associated to each of the local and global proxy representations. Regularizing proxies using an attention mechanism to merge proxy classification decisions may effectively allow unreliable and non-discriminative proxies (and image regions) to be ignored.

Each item of training data may be an image. This may allow a model to be trained that can be used to classify images captured by an image sensor in a device such as a smartphone.

The computer system may be configured to extract features from each image. This may allow the set of proxies to be estimated by global and local pooling of the output of an image feature extractor.

According to a second aspect there is provided a computer system comprising a machine learning system configured to perform a classification task by classifying input data into one of a plurality of classes, the system being configured to: store, for each of multiple classes, multiple proxies, each proxy representing a characteristic of the data belonging to that class; and classify input data by assessing the match between the input data and each of the proxies. The machine learning system may preferably be trained by the computer system described above. This may allow images captured by an image sensor in a device such as a smartphone to be classified according to their content.

According to a third aspect there is provided a method for training a machine learning system to perform a classification task by classifying input data into one of a plurality of classes, the method comprising: receiving per class training data from which per class representations can be derived, wherein each class is described by multiple representations; processing the training data to form, for at least one class, a first proxy for a relatively global portion of an item of training data and multiple proxies for distinct relatively local portions of the item of training data, each proxy corresponding to a representation of the data belonging to that class; and for each item of training data: assessing the match between that item of training data and the proxies, estimating a class for the item of training data in dependence on the level of match, and adjusting the proxies by updating a weighting matrix to reduce the distance between that item of training data and the proxy for the estimated class.

Use of this method may alleviate the inherent bias and limitations linked to the use of a single representation and may allow for the learning of richer proxy representations that can capture latent data distributions accurately and enhance model robustness. Forming a combination of local and global descriptors may enable computation of a set of diverse class proxies that focus on different aspects of the image. The resulting trained models may be able to more effectively handle new classes in data-limited regimes and therefore emulate the related human ability.

The proxies may be defined by weights of a model learned by the machine learning system. This may allow the proxies to be efficiently learned.

The step of processing the training data may comprise, for at least one class, employing a self-supervised rotation prediction training task to strengthen the representation power of the proxies. Using a self-supervised rotation loss task may regularise the learning process on local inputs and strengthen the local proxies' representative power, yielding robust and class-representative local proxies.

The step of processing the training data may comprise, for at least one class, forming multiple proxies by a process configured to encourage variance between those proxies. This may maximise ensembling performance.

The match between an item of training data and the proxies may be assessed by a soft attention mechanism. This can improve the training of the algorithm.

The soft attention mechanism may comprise processing the degree of match between the item of training data and each of the proxies in accordance with a soft attention algorithm, and the method may comprise training the soft attention algorithm to improve the propensity of the system to correctly classify input data.

Each item of training data may be an image. This may allow a model trained by the method to be used to classify images captured by an image sensor in a device such as a smartphone.

The method may further comprise extracting features from each image. This may allow the set of proxies to be estimated by global and local pooling of the output of an image feature extractor.

The method may be performed by a computer system comprising one or more processors programmed with executable code stored non-transiently in one or more memories. This may be helpful in reducing a need to categorise images by hand.

### BRIEF DESCRIPTION OF THE FIGURES

Embodiments of the present application will now be described by way of example with reference to the accompanying drawings. In the drawings:

FIG. 1 shows a t-Stochastic neighbour embedding visualization of feature embeddings for the support and query images in the minilmageNet test stage under the 5-way 1-shot setting.

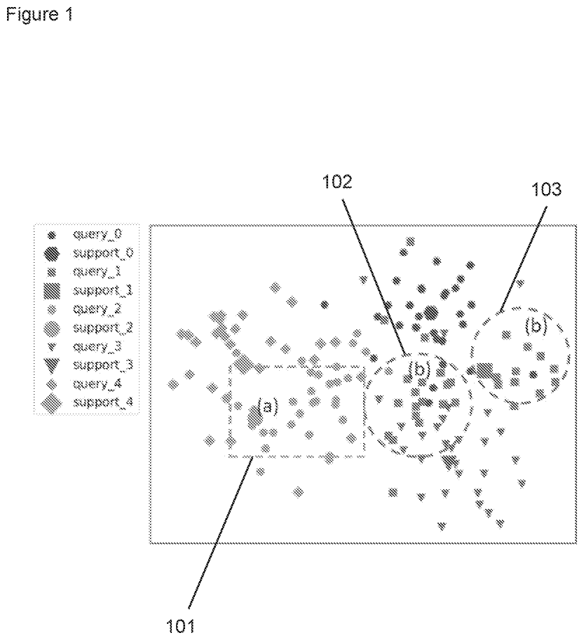

FIG. 2 schematically illustrates an overview of the mixture of proxies model with the imprinted weights implementation.

FIG. 3 shows a flowchart illustrating an example of a method for training a machine learning system to perform a classification task by classifying input data into one of a plurality of classes.

FIG. 4 shows an example of an imaging device configured to implement the computing system and method described herein.

### DETAILED DESCRIPTION OF THE INVENTION

Described herein is a mixture of proxies based metric learning approach for free-shot classification. To address some of the limitations of single proxy metric learning approaches, the mixture of proxies (MP) approach learns multi-modal class representations and can be integrated into existing metric-based methods. The approach described herein focuses on learning high quality proxies and maximally leveraging the use of multiple class-specific representations.

Proxies can be defined as a global representation of a class. In the embodiments described below, class proxies are modelled as a group of feature representations designed to maximize individual (high representative power) and ensembling performance (high inter-proxy variance). This may be achieved by computing a set of local and global class proxies, which allows to focus on different regions and image attributes.

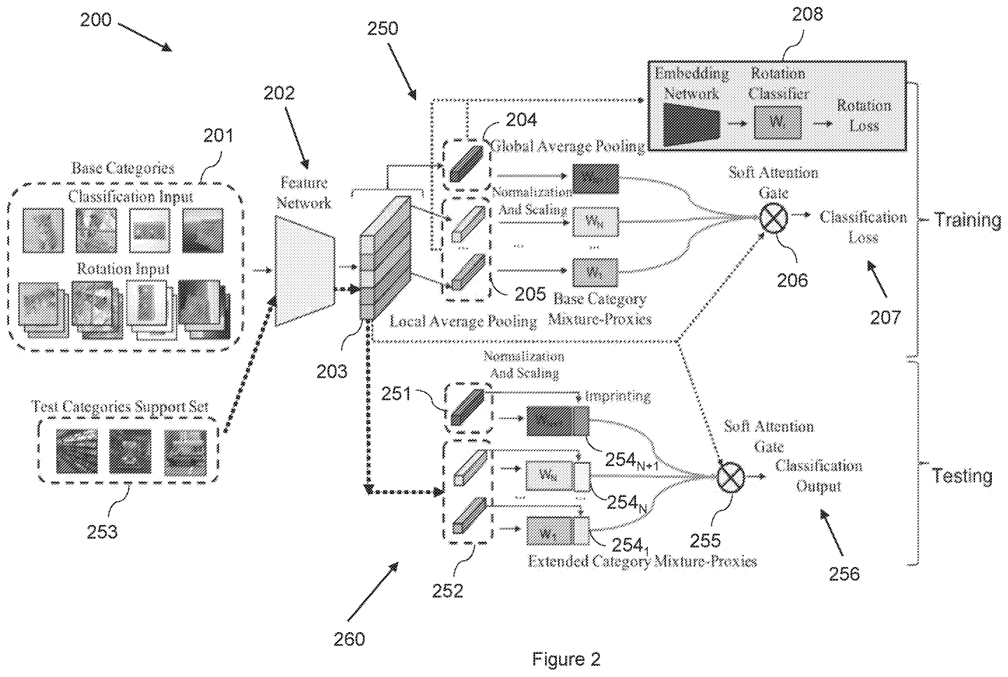

An overview of the machine learning system architecture 200 is schematically illustrated in FIG. 2. Here, the mixture of proxies method is integrated with the imprinted weights FSL method described in Qi, H., Brown, M., and Lowe, D. G., “Low-shot learning with imprinted weights”, CVPR, 2018 as an example. The method may alternatively be integrated with other FSL methods.

The training stage is shown generally at 250. A training set of images 201 is considered that comprises a large set of annotated images and B base categories. The training set comprises per class training data 201 from which per class representations can be derived, wherein each class is described by multiple representations. Using the training set 201, the model is first trained on the base categories. The objective of the method is to learn to label a new set of unseen images, associated with U new unseen categories.

The system is configured to process the training data 201 to form, for each class, multiple proxies W₁-W_{N+1}, each proxy corresponding to a representation of the data belonging to that class. Here, the proxies are defined by weights of the model learned by the machine learning system.

A trainable feature extractor 202 is used to extract features 203 from the images of the training set 201. The set of diverse feature representations (proxies) W₁-W_{N+1}, is estimated by global 204 and local 205 pooling of the output of the trainable image feature extractor 202. Each representation is associated with a trainable classifier (shown at 254₁-254_{N+1} in the test stage). Using global pooling, as shown at 204, a single global proxy W_{N+1} is calculated for each item of training data. This first proxy is therefore determined for a relatively global portion of the item of training data, which is preferably the whole item of training data (e.g. image). Using local pooling, as shown at 205, multiple local proxies W₁-W_{N} are computed. Distinct relatively local portions or regions (i.e. smaller regions than the larger, global portion of the item of training data used to determine the first proxy) of the training images may be used to determine each local proxy.

For each item of training data 201, the system is configured to assess the match between that item of training data and each of the proxies W₁-W_{N+1}, estimate a class for the item of training data in dependence on the level of match, and adjust the proxies by updating a weighting matrix to reduce the distance between that item of training data and the proxy for the estimated class.

In one embodiment, classification decisions may be made based on the scaled cosine distance between the normalized input embeddings and the columns of the classifier weight matrices Wᵢ such that each column of Wᵢ constitutes a trainable class proxy.

As shown at 206, a soft attention gate can be trained to merge classification decisions associated to each of the local and global proxy representations and output the classification loss 207. Thus, local proxies may be regularized with the soft attention gate 206 to merge classification decisions from each of the proxies. This may effectively allow unreliable and non-discriminative proxies (image regions) to be ignored and/or a self-supervised task that regularises the learning process on local inputs, yielding robust and class-representative local proxies.

In some embodiments, feature representations can be optimised using a self-supervised rotation loss associated with a rotation specific embedding network, as shown at 208. This will be described in more detail below.

At test time, as indicated generally at 260 in FIG. 2, proxies can be determined from the embedding of a set of annotated support images. Global and multiple local proxies for new classes can be computed by averaging representations calculated using global 251 and local 252 pooling over a support set 253 and imprinted in the trained classifiers 254₁-254_{N+1}, effectively allowing testing of new classes without retraining the model. As shown at 255, a soft attention gate can merge classification decisions associated to each of the local and global proxy representations and give the classification output 256.

An example of the method will now be described in more detail.

Consider a training dataset D_{base} with annotated samples X_{b}={x₁, . . . , xₙ} and their corresponding labels Y_{b}={y₁, . . . , yₙ} comprising C_{b} base categories. The test dataset Dₙₒᵥₑₗ used herein contains Cₙ novel classes, each of which is associated with only a few labelled samples (for example, less than or equal to 5 samples), while the remaining unlabelled samples are used for evaluation.

The goal of few-shot classification is to learn a classifier on D_{base} that can generalise well to the Cₙ novel classes based on the limited labelled samples from Cₙ novel categories. Specifically, these labelled samples constitute the support set Sₙ with Kₙ annotated samples per class, while the unlabelled samples form the query set Qₙ on which the model is evaluated. This is also referred to as a Cₙ-way Kₙ-shot classification problem. A large set of FSL methods also use the concept of episode training, sampling subsets of support S_{b} and query Q_{b} sets from D_{base} in order to mimic the support-query test scenario.

A global image feature representation is augmented with a set of N local representations focusing on distinct regions through the use of local and global average pooling. These representations, computed on the support set, constitute the class proxies that are subsequently used to classify unlabelled examples using, for example, the cosine distance. This enables the exploitation of high-granularity local descriptors without sacrificing global information. Proxies obtained from local image input may be of poor quality if they focus on ambiguous or irrelevant image regions (e.g. background). This issue may be addressed using a self-supervised rotation loss to learn robust features, and a soft attention gate to combine proxy classification decisions.

The examples described below focus on combining the mixture of proxies approach with metric learning based methods due to their simplicity, flexibility and state of the art performance. However, the method may also be applied to other FSL methods, metric learning based methods and meta-gradient learning based methods.

Metric-based FSL methods focus on learning strong feature representations θ_{f}, which regroup images of the same class and separates different classes with respect to a predefined distance metric γ(·). Depending on the method considered, a proxy p_{c} associated with class c can be defined during training as either (a) the average representation of support set images S_{c} (episodic training methods, see for example Snell, J., Swersky, K., and Zemel, R., “Prototypical networks for few-shot learning”, NeurIPS, 2017), or (b) the c^{th} column of classifier weights trained via standard backpropagation on the base dataset (Qi, H., Brown, M., and Lowe, D. G., “Low-shot learning with imprinted weights”, CVPR, 2018). At test time, all methods preferably employ option (a). Unlabelled images x are then classified based on their embedding distance to the different class proxies γ(x, p_{c}).

The objective is to learn a richer category representation using a mixture of proxies to accurately represent the variability within one class. The support set representation may be decomposed into a set of N+1 proxy representations {p_{c}ⁿ}, n ∈ [1, . . . , N+1], each of which can make individual distance based class assignments.

As summarised above with reference to FIG. 2, the model can be designed so as to maximally leverage multiple proxies through the use of both local and global model component considerations, which may enforce high variance, by employing an auxiliary task using image rotation to increase robustness to local inputs and improve local spatial reasoning, and by using a soft attention gate to increase the influence of reliable proxy predictions. These elements will be described in more detail in the following.

An important criterion for the design of the mixture of proxies is to maximise the variance between proxies so as to minimise redundancy between the representations. To this end, a local and global proxy learning method can be used.

Considering an annotated image x_{b} from the training dataset D_{base}, θ_{f}(x^{b}) is denoted as its representation, where θ_{f}(x^{b}) ∈ \hat{F}×Ŵ×Ĥ and \hat{F}, Ŵ, Ĥ are the feature vector channel, width and height respectively. The features can be extracted from each item of the training dataset by a trainable feature extraction network (shown at 202 in FIG. 2).

Instead of simply using the whole image for average pooling, average pooling may be used on N disjoint local regions (i.e. distinct relatively local portions of the image) which can be obtained by uniformly partitioning the image feature representation along its height H, width W or both such that the nₜₕ local proxy focuses on a specific region Rₙ of the input image. The number of proxies along the height and/or width can constitute a hyperparameter.

By designing local proxies that focus on disjoint parts of the image, the proxies may be forced to provide complementary information and limit redundancy. However, relying solely on fine-grained, local representations may disregard global, high level information that can also provide highly useful cues. As a result, the set of multiple local proxy representations pₙ, n ∈ [1, . . . N+1] may be combined with a global proxy p_{N+1} that considers the whole image, computed in parallel by global average pooling of θ_{f}(x^{b}). This combination of local and global descriptors may enable computation of a set of diverse class proxies that focus on different aspects of the image.

However, in some embodiments, a naive use of multiple local descriptors can result in two problems that may limit the performance of multi-proxy strategies. Firstly, learning accurate embeddings and classifiers using local proxies can be challenging and reaches subpar performance, due to the potential ambiguity associated with partial image inputs. Secondly, local proxies may focus on non-discriminative image regions and therefore provide no relevant information. These potential problems may be addressed by regularising local proxies with self-supervision and ensembling proxy predictions with attention, as will be described in more detail below.

Recent advances in unsupervised and semi-supervised learning have demonstrated the advantage of self-supervision to regularise model training and learn stronger feature representations. Training classifiers using local image information provides a scenario with an analogous challenges, where local information can be ambiguous or may not even contain the class of interest. This potentially unreliable signal may in some implementations harm model training and may yield sub-optimal proxy representations. Integration of a self-supervised auxiliary task may allow the learning of more robust features, and therefore proxies, by extracting features suitable for multiple high level tasks. This effectively allows for optimisation of the local proxies' representative power.

In some embodiments, an auxiliary rotation task may be used (as schematically illustrated at 208 in FIG. 2). This may be particularly advantageous because rigid rotation retains spatial contiguity and image properties helpful to the main task, unlike other common alternatives that may be used, for example jigsaw puzzle tasks (see, for example Su, J.-C., Maji, S., and Hariharan, B., “Boosting supervision with self-supervision for few-shot learning”, arXiv, 2019). Formally, given a training image x^{b} from D_{base}, four rigidly transformed images can be produced by rotating x^{b} by r degrees, where r ∈ {0°, 90°, 180°, 270°}. The auxiliary rotation task can be formulated as a four class classification problem, where the objective is to correctly recognize rotation r. This can be achieved by training a linear classifier Wᵣ after passing image local embeddings of θ_{f}(cᵢ^{b})ₙ, n ∈ [1, . . . , N] and global embedding θ_{f}(xᵢ^{b})_{N+1} through a 1×1 convolution layer. This additional convolutional layer adapts the feature vector θ_{f}(xᵢ^{b}) to the rotation task and additionally implicitly discourages conflict with the main classification task. The rotation branch can then be finally trained using a standard softmax cross-entropy loss:

$${ℒ}_{rotate} = - \frac{{\sum }_{i = 1}^{N + 1} {\sum }_{c = 1}^{4} {δ}_{c , y} log ( {ρ}_{c} ( Φ ( {{θ}_{f} ( x )}_{i} )}{N + 1} \qquad ( 1 )$$

where Φ is the rotation embedding function, ρ_{c} is the rotation prediction score and δ_{c,y} is the Dirac delta function.

Therefore, in some embodiments, a rotation prediction task can be added in parallel to the class prediction to regularise the training process and improve performance. The representation power of the formed proxies may therefore be strengthened in some implementations of the method by employing a self-supervised rotation prediction auxiliary training task.

An embodiment of the method including ensembling proxy predictions with attention will now be described.

Local proxy classification task utility may vary. In embodiments of the method described herein, task utility and weight proxy ensembles may be learned using attention.

For a given input image x, proxy-specific classification scores fₙ(x) are associated to image region Rₙ, and are computed as the normalised distance between the embedding of θ_{f}(x)ₙ and proxies pₙ of all C_{N} classes:

$${f}_{n}^{c} ( x ) = \frac{exp ( ( {p}_{n}^{c} , {{θ}_{f} ( x )}_{n} ) )}{{\sum }_{j = 1}^{{C}_{N}} exp ( ( {p}_{n}^{j} , {{θ}_{f} ( x )}_{n} ) )} \qquad ( 2 )$$

where fₙ^{c} and pₙ^{c} are, respectively, the classification score and proxy associated with class c.

A straightforward strategy may be to average all proxy decisions to obtain an ensemble global score. However, in some implementations, such a strategy may be affected by uninformative local proxies focusing on nondiscriminative regions. Alternatively, in a preferred implementation, a soft attention gate may be integrated, thus modulating the combination of proxy decisions and affording attenuation of the signal propagated by low quality proxies.

The soft attention gate [symbol] may be designed as a single softmax and fully connected layer, taking as input the global image representation θ_{f}(x), reshaped into a vector. The attention weight of each proxy α={αₙ} can then be calculated as α= [symbol] (θ_{f}(x))+1.

To mitigate any potential errors induced by noisy or difficult examples, the gate combined with a residual connection using, for example, the method described Wang, F., Jiang, M., Qian, C., Yang, S., Li, C., Zhang, H., Wang, X., and Tang, X, “Residual attention network for image classification”, CVPR, 2017. This may yield more robust performance to inaccurate attention weights.

Finally, classification scores for image x may be computed as:

$$f ( x ) = \frac{{\sum }_{n = 1}^{N + 1} {α}_{n} {f}_{n} ( x )}{N + 1} \qquad ( 3 )$$

The model's classification branch can then be trained using the predictions and standard metric learning strategies.

The mixture of proxies model described above may provide a general formulation that can easily be integrated in conjunction with popular metric-based few-shot learning models.

As described above, in a preferred embodiment, as schematically illustrated in FIG. 2, the mixture of proxies model can be implemented with the imprinted weights model described in Qi, H., Brown, M., and Lowe, D. G., “Low-shot learning with imprinted weights”, CVPR, 2018. Other episode training strategies may also be used.

The imprinted weights approach trains a classifier on the whole set of base classes C_{b}. The architecture comprises a feature extraction network θ_{f}, followed by a classifier comprising a fully connected layer without bias W ∈F×C_{b} where F is the output dimension of θ_{f}. W may be learned such that the cosine distance between w_{c} (the c^{th} column of W) and the embedding θ_{f}(x_{c}) of input images of class c is minimal.

Thus, w_{c} can be seen as the proxy of the c^{th} category in the base set. The objective function aims to minimise the cosine distance between images and their corresponding proxy.

Use of the imprinted weights model provides two main advantages. Firstly, due to the training strategy, each row of the classifier matrix W constitutes a proxy, allowing new categories to easily be imprinted in W using the support set proxy. This may alleviate the need to retrain or fine-tune a model when new categories are available or when the number of shots is changed, yielding a highly efficient model with continual learning ability. Secondly, the classifier training approach does not require a cumbersome episodic training process. However, traditionally, the imprinting strategy may make the model highly sensitive to proxy quality and easily fails in the single proxy scenario.

The mixture of proxies approach described herein focuses on strong multi-modal representations and allows full exploitation of the benefits of this model while maintaining robust performance. In this context, the mixture of proxies approach may be integrated in a natural way, associating each of the N local and single global feature vectors with a different classifier.

As discussed previously, classification decisions may, for example, be computed by evaluating the cosine distance between an input image and each column of a given classifier matrix, where a column corresponds to a class. As such, classifier weights can be learned to minimise the distance between embeddings and proxies (classifier columns) of the same class.

As each classifier focuses on different feature regions of images, it is possible to automatically learn the N+1 multiple diverse local proxies and global proxy as columns of each classifier matrix, W₁, W₂, . . . , W_{N+1}. Specifically, for a given classifier Wᵢ, the classification score of sample x for class c can be computed as:

$${f}_{i}^{c} ( x ) = \frac{exp ( γ ( {w}_{ic}^{T} , {{θ}_{f} ( x )}_{i} )}{{\sum }_{j = 1}^{{C}_{b}} exp ( γ ( {w}_{ij}^{T} , {{θ}_{f} ( x )}_{i} )} \qquad ( 4 )$$

where wᵢⱼ is the j^{th} column of weight matrix Wᵢ and corresponds to proxy pᵢⱼ associated with region Rᵢ and class j. The scaled cosine similarity is defined as γ(wⱼ^{T}, θ_{f}(x))=swᵢ^{T}(θ_{f}(x)).

Both Wᵢ and θ_{f} (x) can be normalized using the L₂ norm, and s is a trainable scalar (as described in Qi, H., Brown, M., and Lowe, D. G., “Low-shot learning with imprinted weights”, CVPR, 2018). This may help to avoid the risk that the cosine distance yields distributions that lack discriminative power.

Then, the classification loss function is calculated as follow:

$${ℒ}_{ce} = - \frac{{\sum }_{c = 1}^{{C}_{b}} {δ}_{c , y} log {f}^{c} ( x ) + {\sum }_{n = 1}^{N + 1} {\sum }_{c = 1}^{{C}_{b}} {δ}_{c , y} log {f}_{n}^{c} ( x )}{N + 2} \qquad ( 5 )$$

where f^{c} is computed from all fᵢ^{c} using Equation (3) and δ_{c,y} is the Dirac delta function. A summation of individual logfᵢ^{c}(x) terms is retained in Equation (5) such that each proxy can be pushed to possess discriminative class information.

The whole model can then be trained end-to-end using the objective function [symbol] = [symbol] _{ce}+ [symbol] ᵣₒₜₐₜₑ. At test time, given a new category j from Dₙₒᵥₑₗ with support dataset Sⱼ, a new set of proxies can be computed as:

$${p}_{nj}^{*} = \frac{1}{\vert {s}_{j} \vert} {\sum }_{{x}_{i}^{S} ∈ {S}_{j}} {{θ}_{f} ( {x}_{i}^{S} )}_{n} , ∀ n ∈ [ 1 , … , N + 1 ] \qquad ( 6 )$$

where Sⱼ contains all annotated samples in the j^{th} category.

By imprinting classifier W*ₙ with p*ₙⱼ=w*ₙⱼ and repeating the process for any new category, new classes may be recognised without retraining the model. By concatenating Wₙ and W*ₙ, the model may be tested on all Cₙ+C_{b} categories.

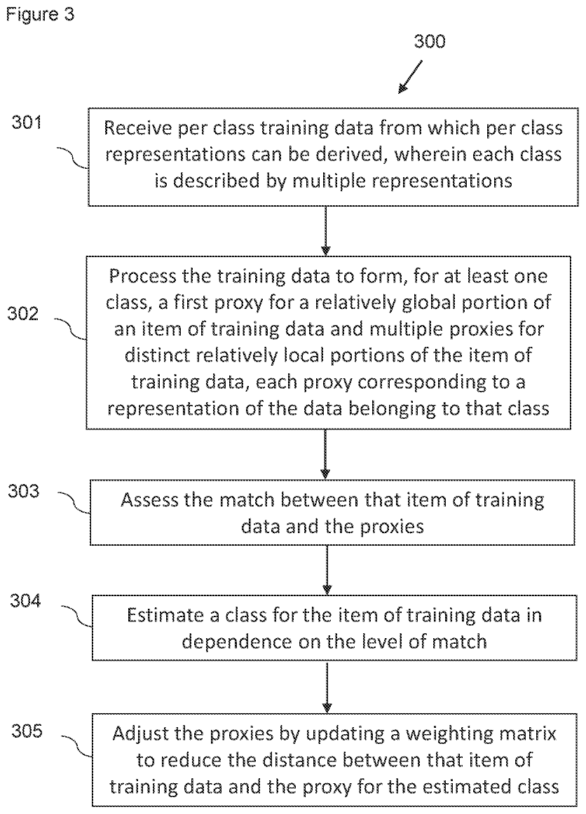

FIG. 3 summarises an example of a method 300 for training a machine learning system to perform a classification task by classifying input data into one of a plurality of classes. At step 301, the method comprises receiving per class training data from which per class representations can be derived, wherein each class is described by multiple representations. At step 302, the method comprises processing the training data to form, for at least one class, a first proxy for a relatively global portion of an item of training data and multiple proxies for distinct relatively local portions of the item of training data, each proxy corresponding to a representation of the data belonging to that class. For each item of training data, the following steps 303-305 are then performed. At step 303, the method comprises assessing the match between that item of training data and the proxies. At step 304, the method comprises estimating a class for the item of training data in dependence on the level of match. At step 305, the method comprises adjusting the proxies by updating a weighting matrix to reduce the distance between that item of training data and the proxy for the estimated class.

The method can be implemented on a computer system suitable for training a machine learning system to perform a classification task by classifying input data into one of a plurality of classes.

The trained model can be implemented on a computer system comprising a machine learning system configured to perform the classification task by classifying input data into one of a plurality of classes. The system is configured to: store, for each of multiple classes, multiple proxies, each proxy representing a characteristic of the data belonging to that class; and classify input data by assessing the match between the input data and each of the proxies.

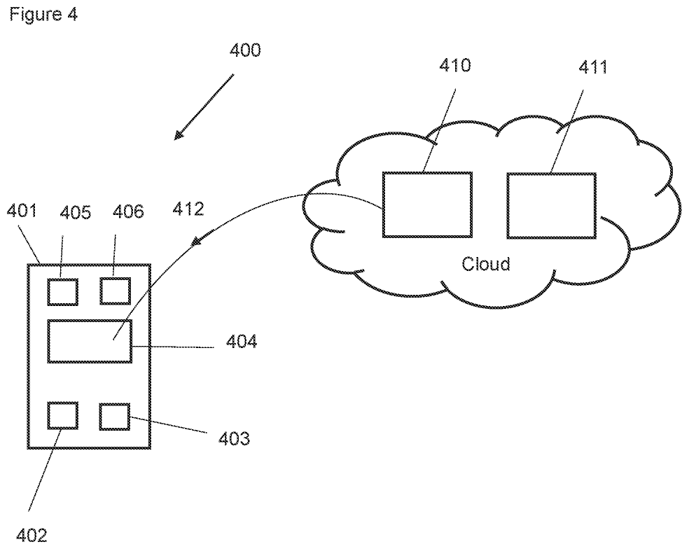

FIG. 4 shows an example of a system 400 comprising a device 401 configured to use the method described herein to train the system to perform the classification task and/or to classify image data captured by at least one image sensor in the device.

In this example, the device 401 comprises image sensors 402, 403. Such a device 401 typically includes some on board processing capability. This could be provided by processor 404. The processor 404 could also be used for the essential functions of the device. The device also comprises a memory 406. The memory may store in a non-transient way code that is executable by the processor to implement methods and operation of the device.

The transceiver 405 is capable of communicating over a network with other entities 410, 411. Those entities may be physically remote from the device 401. The network may be a publicly accessible network such as the internet. The entities 410, 411 may be based in the cloud. Entity 410 is a computing entity. Entity 411 is a command and control entity. These entities are logical entities. In practice they may each be provided by one or more physical devices such as servers and data stores, and the functions of two or more of the entities may be provided by a single physical device. Each physical device implementing an entity comprises a processor and a memory. The devices may also comprise a transceiver for transmitting and receiving data to and from the transceiver 405 of device 401. The memory stores in a non-transient way code that is executable by the processor to implement the respective entity in the manner described herein.

The command and control entity 411 may train the artificial intelligence models used in the device. This is typically a computationally intensive task, even though the resulting model may be efficiently described, so it may be efficient for the development of the algorithm to be performed in the cloud, where it can be anticipated that significant energy and computing resource is available. It can be anticipated that this is more efficient than forming such a model at a typical imaging device.

In one implementation, once the algorithms have been developed in the cloud, the command and control entity can automatically form a corresponding model and cause it to be transmitted to the relevant imaging device. In this example, the model is implemented at the device 401 by processor 404.

In another possible implementation, an image may be captured by one or both of the sensors 402, 403 and the image data may be sent by the transceiver 405 to the cloud for processing to classify the image. The resulting image could then be sent back to the device 401, as shown at 412 in FIG. 4.

Therefore, the method may be deployed in multiple ways, for example in the cloud, on the device, or alternatively in dedicated hardware. As indicated above, the cloud facility could perform training to develop new algorithms or refine existing ones. Depending on the compute capability near to the data corpus, the training could either be undertaken close to the source data, or could be undertaken in the cloud, e.g. using an inference engine. The method may also be implemented at the device, in a dedicated piece of hardware, or in the cloud.

Existing metric based FSL approaches typically limit class representation to a unimodal proxy, whereas the approach described herein offers a solution to the important limitations commonly associated with such strategies. To address limitations of previous methods, a mixture of proxies approach is described herein that learns multimodal class representations and can be integrated into existing metric based methods. The approach described herein may alleviate the inherent bias and limitations linked to the use of a single representation and may allow for the learning of richer proxy representations that can capture latent data distributions accurately and enhance model robustness. This may solve a problem of FSL for image classification: teaching models to handle new classes in data-limited regimes (and therefore to emulate the related human ability).

As described above, a set of proxies is learned per class that are optimised to maximise individual (high representative power) and ensembling performance (high inter-proxy variance). Class proxies are modelled as a group of feature representations carefully designed to be highly diverse and maximise ensembling performance. This may be achieved by computing a set of local and global feature vectors, which allows to focus on different regions and image attributes. Local proxies can be regularized with a soft attention gate to merge proxy classification decisions, effectively allowing unreliable and non-discriminative proxies (image regions) to be ignored and a self-supervised rotation loss task that regularises the learning process on local inputs and strengthens the local proxies' representative power, yielding robust and class-representative local proxies.

Image level representations are therefore combined with local descriptors and carefully regularise local proxy influence using self-supervision and attention to maximise proxy diversity and representative power. This approach allows for separation and generalisation to new classes accurately due to the resulting richer representations and the model is designed to jointly optimise proxy variance and representative power.

The MP learning strategy for FSL described herein provides a simple and generic approach that can easily be embedded in pre-existing metric learning based methods.

The increased robustness of representations granted by the mixture of proxies allows for integration of the method with the imprinted weights single proxy approach to yield a highly efficient formulation that also maintains high accuracy due to the high-quality proxy representations. The model may be trained only once, affording an efficient and unified model that does not require retraining when the number of training shots are changed, or when new classes are available. Therefore, a shot free model may be trained that may continually adapts to new classes without re-training.

Experiments on minilmageNet and tieredImageNet have shown that integrating MP with metric learning approaches may boost performance, while the imprinted weights MP model has, in some implementations, been shown to outperform the classification accuracy of the current state of the art by over 3% (minilmageNet) and 1.5% (tieredImageNet) accuracy in 1-shot and 5-shot settings.

In contrast to pre-existing multi-proxies approaches, such as the methods described in Allen, K. R., Shelhamer, E., Shin, H., and Tenenbaum, J. B., “Infinite mixture prototypes for few-shot learning”, arXiv, 2019 and Li, W., Wang, L., Xu, J., Huo, J., Gao, Y., and Luo, J., “Revisiting local descriptor based image-to-class measure for few-shot learning”, CVPR, 2019, the MP method is highly diverse and can use attention to identify proxy importance and self-supervision to optimise local proxies' representative power. This allows to fully leverage the proxy mixture approach, and may improve individual and ensembled proxy classification decisions.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A computer system configured for training a machine learning system to perform a classification task by classifying input data into one of a plurality of classes, the computer system comprising:
a memory configured to store processor-executable instructions; and
a processor configured to execute the processor-executable instructions to cause the computer system to:
receive per class training data from which per class representations can be derived, wherein each class is described by multiple representations;
process the training data to form, for at least one class, (a) a first proxy for a relatively global portion of an item of training data, and (b) multiple proxies for distinct relatively local portions of the item of training data, wherein each proxy corresponding to a representation of the data belongs to that class; and
for each item of training data: assess a match between that item of training data and the proxies, estimate a class for the item of training data in dependence on a level of match, and adjust the proxies by updating a weighting matrix to reduce the distance between that item of training data and the proxy for the estimated class.

2. The computer system as claimed in claim 1, wherein the proxies are defined by weights of a model learned by the machine learning system.

3. The computer system as claimed in claim 1, wherein the processing the training data further comprises:
for at least one class, employing a self-supervised rotation prediction training task to strengthen representation power of the proxies.

4. The computer system as claimed in claim 1, wherein the processor is further configured to execute the processor-executable instructions to cause the computer system to:
the system being configured to assess the match between an item of training data and the proxies by a soft attention mechanism.

5. The computer system as claimed in claim 4, wherein the soft attention mechanism comprises:
processing a degree of match between the item of training data and each of the proxies in accordance with a soft attention algorithm, and
wherein the processor is further configured to execute the processor-executable instructions to cause the computer system to: train the soft attention algorithm to correctly classify input data in order to improve the propensity of the machine learning system.

6. The computer system as claimed in claim 1, wherein each item of training data is an image.

7. The computer system as claimed in claim 6, wherein the processor is further configured to execute the processor-executable instructions to cause the computer system to:
extract features from each image.

8. A computer system comprising a machine learning system trained by another computer system and configured to perform a classification task by classifying input data into one of a plurality of classes,
wherein the computer system comprises:
a memory configured to store processor-executable instructions; and
a processor configured to execute the processor-executable instructions to cause the computer system to:
store, for each of multiple classes, multiple proxies, each proxy representing a characteristic of data belonging to that class; and
classify input data by assessing a match between the input data and each of the proxies;
wherein the another computer system comprises:
an another memory configured to store processor-executable instructions; and
an another processor configured to execute the processor-executable instructions to cause the another computer system to:
receive per class training data from which per class representations can be derived, wherein each class is described by multiple representations;
process the training data to form, for at least one class, (a) a first proxy for a relatively global portion of an item of training data, and (b) multiple proxies for distinct relatively local portions of the item of training data, wherein each proxy corresponding to a representation of the data belongs to that class; and
for each item of training data: assess a match between that item of training data and the proxies, estimate a class for the item of training data in dependence on a level of match, and adjust the proxies by updating a weighting matrix to reduce the distance between that item of training data and the proxy for the estimated class.

9. A method for training a machine learning system to perform a classification task by classifying input data into one of a plurality of classes, the method which is applied to a computer system comprising:
receiving per class training data from which per class representations can be derived, wherein each class is described by multiple representations;
processing the training data to form, for at least one class, (a) a first proxy for a relatively global portion of an item of training data, and (b) multiple proxies for distinct relatively local portions of the item of training data, wherein each proxy corresponding to a representation of the data belongs to that class; and
for each item of training data: assessing a match between that item of training data and the proxies, estimating a class for the item of training data in dependence on a level of match, and adjusting the proxies by updating a weighting matrix to reduce the distance between that item of training data and the proxy for the estimated class.

10. The method as claimed in claim 9, wherein the proxies are defined by weights of a model learned by the machine learning system.

11. The method as claimed in claim 9, wherein the processing the training data further comprises: for at least one class, employing a self-supervised rotation prediction training task to strengthen representation power of the proxies.

12. The method as claimed in claim 9, wherein the match between an item of training data and the proxies is assessed by a soft attention mechanism.

13. The method as claimed in claim 12, wherein the soft attention mechanism comprises processing a degree of match between the item of training data and each of the proxies in accordance with a soft attention algorithm, and wherein the method further comprises: training the soft attention algorithm to correctly classify input data in order to improve propensity of the machine learning system.

14. The method as claimed in claim 9, wherein each item of training data is an image.

15. The method as claimed in claim 14, wherein the further comprising:
extracting features from each image.

16. The method as claimed in claim 9, wherein the computer system comprises one or more processors programmed with executable code stored non-transiently in one or more memories.

17. The computer system as claimed in claim 8, wherein the proxies are defined by weights of a model learned by the machine learning system.

18. The computer system as claimed in claim 8, wherein the processing the training data further comprises:
for at least one class, employing a self-supervised rotation prediction training task to strengthen representation power of the proxies.

19. The computer system as claimed in claim 8, wherein the another processor is further configured to execute the processor-executable instructions to cause the another computer system to:
assess the match between an item of training data and the proxies by a soft attention mechanism.

20. The computer system as claimed in claim 19, wherein the soft attention mechanism comprises:
processing a degree of match between the item of training data and each of the proxies in accordance with a soft attention algorithm, and
wherein the another processor is further configured to execute the processor-executable instructions to cause the another computer system to: train the soft attention algorithm to correctly classify input data in order to improve the propensity of the machine learning system.
